(19) United States
(12) Patent Application Publication
(10) Pub. No.: US 2026/0131973 A1
(43) Pub. Date: May 14, 2026

(54) TRANSPORT DEVICE FOR STORING AND RETRIEVING PRODUCTS IN A SHELF WAREHOUSE AND METHOD FOR STORING AND RETRIEVING PRODUCTS IN A SHELF WAREHOUSE

(71) Applicant: Dambach Lagersysteme GmbH & Co KG, Bischweier (DE)

(72) Inventor: Roland THUMM, Birkweiler (DE)

(73) Assignee: Dambach Lagersysteme GmbH & Co KG, Bischweier (DE)

(21) Appl. No.: 19/432,914

(22) Filed: Dec. 24, 2025

Related U.S. Application Data
(63) Continuation of application No. PCT/EP2024/067886, filed on Jun. 26, 2024.

(30) Foreign Application Priority Data
Jun. 28, 2023 (DE) 10 2023 117 076.7

(51) Int. Cl. B65G 1/04; G05D 1/225; G05D 1/243; G05D 107/70

(52) U.S. Cl. CPC B65G 1/0492; G05D 1/225; G05D 1/243; G05D 2107/70

(57) ABSTRACT

A transport device for storing and retrieving products in a shelf warehouse having at least one shelf aisle and at least one shelf, has a satellite vehicle that can be moved along the shelf via a propulsion device and has a support surface on which a product can be supported. The product can be lifted relative to the satellite vehicle via a lifting device. A carrier vehicle, which can be moved along the shelf aisle via a drive device, has a receiving area on which the satellite vehicle can be arranged. The carrier vehicle has a first sensor device via which a current position of the satellite vehicle on the receiving area and/or a current position of the product located on the satellite vehicle can be detected. A control device sends correction signals to the propulsion device of the satellite vehicle if the deviation is greater than a predetermined value.

This nonprovisional application is a continuation of International Application No. PCT/EP 2024/067886, which was filed on Jun. 26, 2024, and which claims priority to German Patent Application No. 10 2023 117 076.7, which was filed in Germany on Jun. 28, 2023, and which are both herein incorporated by reference.

### BACKGROUND OF THE INVENTION

### Field of the Invention

The invention relates to a transport device for storing and retrieving products in a shelf warehouse which has at least one shelf aisle and at least one shelf extending perpendicular to the shelf aisle, wherein the transport device has a satellite vehicle that can be moved along the shelf via a propulsion device and has a support surface on which a product can be supported, and which has a lifting device via which the product can be raised and lowered relative to a chassis of the satellite vehicle via a lifting drive device, wherein the transport device has a carrier vehicle which is movable along the shelf aisle via a drive device and which has a receiving area on which the satellite vehicle can be arranged with or without a product placed thereon.

Furthermore, the invention relates to a method for storing and retrieving products in a shelf warehouse which has at least one shelf aisle and at least one shelf extending perpendicular to the shelf aisle, wherein the satellite vehicle with the product arranged on the support surface drives onto the receiving area of the carrier vehicle via the propulsion device and is stopped there.

### Description of the Background Art

A transport device is known from EP 2 780 260 B1, which corresponds to U.S. Pat. No. 9,850,066, and serves to quickly place products, for example pallets with attached containers, into or remove them from shelves of a shelf warehouse. The shelves are designed to be multiple depths, meaning that several products can be arranged in a row perpendicular to the shelf aisle in one shelf. To retrieve a product, the carrier vehicle, which carries the satellite vehicle at its receiving area, travels along the shelf aisle of the rack to the position in which the shelf from which the product is to be retrieved is located. Once the correct position in the shelf aisle has been reached, the propulsion device of the satellite vehicle is activated, the latter leaving the carrier vehicle and traveling into the shelf until it is disposed below the product to be retrieved. The lifting device is then activated, and the product is lifted within the shelf so that it now sits on the support surface of the satellite vehicle. The satellite vehicle is then moved back along the shelf to the carrier vehicle via the propulsion device until it is seated in its receiving area. The lifting device is then lowered, whereby the product is lowered and placed on a circulating conveyor of the carrier vehicle. The conveyor is assigned its own drive device, via which the product can be moved on the carrier vehicle and aligned therewith in the desired manner. The carrier vehicle then travels together with the satellite vehicle and the picked-up product along the shelf aisle, preferably to its end.

The circulating conveyor of the carrier vehicle and its drive device make the design very complex and expensive. Furthermore, these two components increase the weight of the carrier vehicle, which is disadvantageous both in terms of energy and also in terms of working speed.

### SUMMARY OF THE INVENTION

It is therefore an object of the present invention to create a transport device for storing and retrieving products in a shelf warehouse, in which the alignment of the product relative to the carrier vehicle is possible in a structurally simple manner.

Furthermore, a method for storing and retrieving products in a shelf warehouse is provided, which allows a product or load to be handled quickly and easily.

This object is achieved with a transport device according to the invention. In an example, it is provided that the carrier vehicle has a first sensor device, via which a current position of the satellite vehicle on the receiving area and/or a current position of the product located on the satellite vehicle, for example a pallet and/or a crate or cardboard box, can be detected, said first sensor device transmitting corresponding first position signals to a control device in which the respective current position is comparable to a target position, wherein the control device is designed such that it sends correction signals to the propulsion device of the satellite vehicle if the deviation between the current position and the target position is greater than a predetermined value.

According to an example of the invention, a basic idea is to detect the position of the satellite vehicle and/or the product on the carrier vehicle and to bring about any correction solely via the propulsion device of the satellite vehicle. Therefore, an additional circulating conveyor and its additional drive device can be dispensed with.

Preferably, an optical sensor device can be used as the first sensor device which, for example, has at least one camera and/or at least one light barrier and/or at least one optical scanner and, in particular, a laser scanner.

It can be provided that the satellite vehicle with the product first drives onto the receiving area of the carrier vehicle and stops there, whereupon the current position of the product and/or the satellite vehicle is detected, and subsequently a one-time or multiple correction of the position of the satellite vehicle and the product is carried out by activating the propulsion device of the satellite vehicle.

It can also be provided that the current position of the satellite vehicle and/or the product is already detected while the satellite vehicle is driving with the product to the receiving area of the carrier vehicle. Once the target position is reached, the drive device of the satellite vehicle is stopped. If necessary, it can finally be checked again whether the target position has actually been reached correctly.

Since any position correction of the product and the satellite vehicle is carried out by activating the drive device of the satellite vehicle, the first sensor device is connected by way of controlling to the propulsion device of the satellite vehicle. The first sensor device sends first position signals to the control device which in turn influences the propulsion device of the satellite vehicle via possible correction signals. It can be provided that the control device is located on the carrier vehicle such that the correction signals are preferably transmitted wirelessly from the control device to the propulsion device of the satellite vehicle or to a further control device upstream from there.

Further, it can be provided that the control device can be arranged on the satellite vehicle and that the first sensor device thereby transmits the first position signals wirelessly to the control device.

It can be provided that the satellite vehicle can have a second sensor device with which the current position of the satellite vehicle on the receiving area can be detected and that transmits corresponding second position signals to the control device, with which the current position can be compared with the target position. Such an example can be used, for example, when the first sensor device only detects the current position of the product, and it is also desired to detect the current position of the satellite vehicle. If the first sensor device detects both the current position of the product and the current position of the satellite vehicle, the second sensor device arranged on the satellite vehicle can be used for additional position detection and therefore higher positioning accuracy.

The second sensor device can also be designed as an optical sensor device is and can for example, have at least one camera and/or at least one light barrier and/or at least one optical scanner and, in particular, a laser scanner.

The target position of the product and/or the satellite vehicle can be reached via a control system and therefore by detection and correction that is carried out continuously or in short intervals. Alternatively, it is possible to detect the current position of the product and/or the satellite vehicle and calculate a correction value by which the satellite vehicle with the load on the carrier vehicle must be moved. Since precise servomotors are usually used as drive devices, the control device can in this case calculate and initiate an angle as a correction value by which the servomotor is adjusted. This leads to a corresponding rotation of the wheels of the satellite vehicle and therefore its corrective movement.

The second sensor device of the satellite vehicle can also be used to control and monitor the movement of the satellite vehicle in the shelf. In an example of the invention, it can be provided that the control device specifies a desired position for the satellite vehicle in the shelf and accordingly controls the propulsion device of the satellite vehicle. During and at the end of the driving movement of the satellite vehicle, it is possible to monitor whether the satellite vehicle has already reached the desired position.

Additional sensor devices can be provided on the satellite vehicle and/or the carrier vehicle that, for example, detect the weight of the product or of the satellite vehicle with the product placed thereon, or the total weight of the carrier vehicle with the satellite vehicle and the product placed thereon, and, optionally, compare it with a predetermined target value.

In extreme areas of application, for example in shelf warehouses for frozen foods in which temperatures of −25° C. to −30° C. usually prevail, or in shelf warehouses in which the products have to be kept in a warm environment of, for example, +30° C., thermal expansion and thermal shrinkage of the components occur due to the extreme temperatures, which can lead to inaccurate position corrections that then have to be corrected again. To avoid this, it can be provided in a further development of the invention that a third sensor device is provided that detects the temperature in the vicinity of the carrier vehicle and/or the satellite vehicle and sends corresponding temperature signals to the control device. The control device takes the ambient temperature into account when calculating the correction values for the propulsion device of the satellite vehicle.

The method according to the invention is distinguished in that the satellite vehicle with the product arranged on the support surface drives onto the receiving area of the carrier vehicle via the propulsion device and is stopped there. Possibly already during the approach of the satellite vehicle to the receiving area of the carrier vehicle and at least after the satellite vehicle has stopped, the current position of the satellite vehicle on the receiving area and/or the current position of the product located on the satellite vehicle is detected via the first sensor device. The first sensor device transmits corresponding first position signals to the control device, whereupon the control device compares the current position with the target position, and the control device sends correction signals to the propulsion device of the satellite vehicle if the deviations between the current position and the target position are greater than a predetermined value. Depending on the correction signals, the propulsion device is activated, and the position of the satellite vehicle on the receiving area is changed via the propulsion device. A corresponding correction can be made once or several times in succession.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### DETAILED DESCRIPTION

The present invention will become more fully understood from the detailed description given hereinbelow and the accompanying drawings which are given by way of illustration only, and thus, are not limitive of the present invention, and wherein:

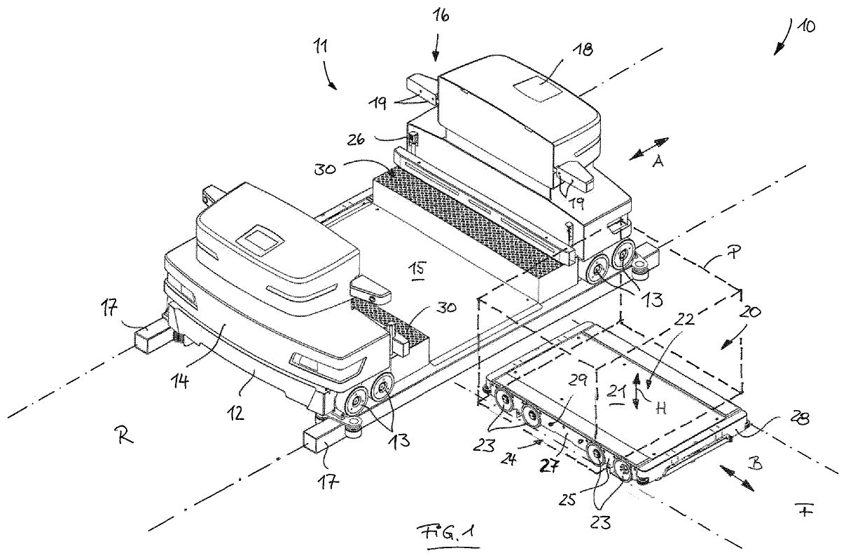

FIG. 1 shows the transport device with a carrier vehicle and a satellite vehicle,

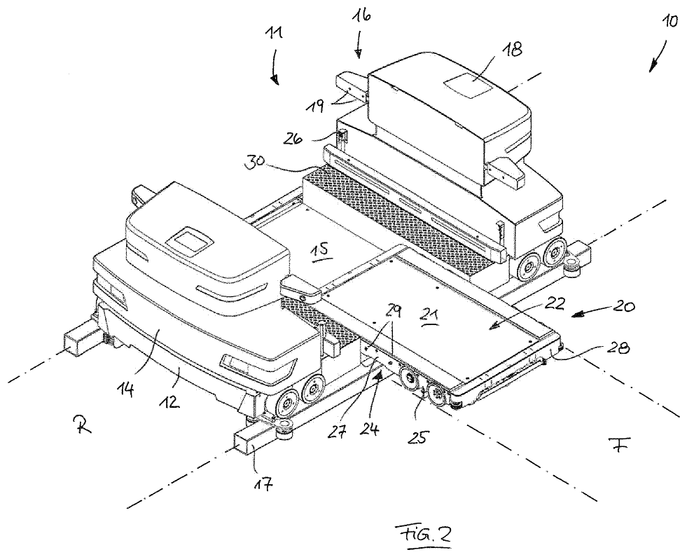

FIG. 2 shows the satellite vehicle while driving onto the carrier vehicle, and

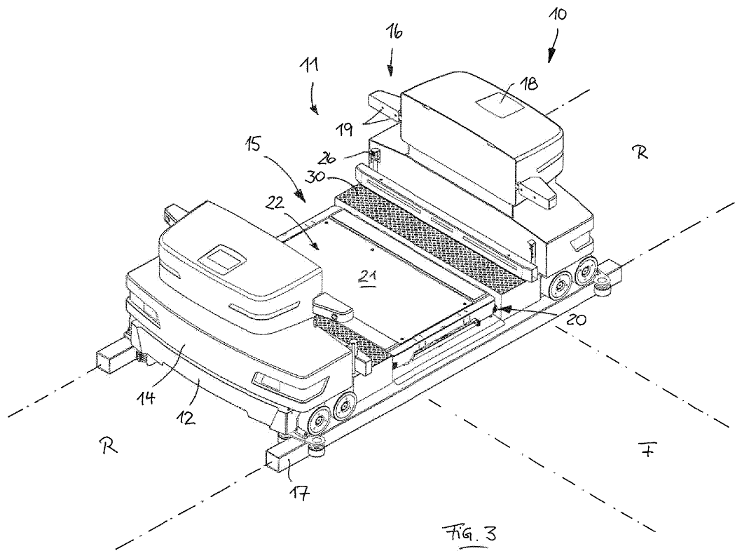

FIG. 3 shows the satellite vehicle on the carrier vehicle.

### DETAILED DESCRIPTION

FIG. 1 shows a transport device 10 for storing and retrieving products (loads) in a shelf warehouse. The shelf warehouse has a shelf aisle R (indicated only) and a shelf F extending perpendicular to the shelf aisle R (also indicated only). A carrier vehicle 11 is supported by wheels 13 on rails 17 by wheels 13 and can be moved bidirectionally along the shelf aisle R via a drive device 14, as indicated by the double arrow A.

A satellite vehicle 20 can be moved bidirectionally along the shelf aisle F via a propulsion device 25, as indicated by the double arrow B, and is supported on the shelf aisle by wheels 23. On its upper side, the satellite vehicle 20 has a support surface 21 onto which a product P, shown only as a dashed line in FIG. 1 for the sake of clarity, can be placed. The majority of the support surface 21 is formed by a plate-shaped lifting device 22 which can be raised via a lifting drive device 27 so that the product P placed on the support surface 21 can be raised and lowered relative to a chassis 28 of the satellite vehicle 20, as is also indicated by the double arrow H.

A receiving area 15 is formed on the carrier vehicle 11, onto which the satellite vehicle 21 can be driven with or without the product P mounted thereon so that the satellite vehicle 20 and the product P are completely arranged on the carrier vehicle 21 without protruding laterally therefrom.

There is a first sensor device 16 with a plurality of sensors 19 arranged on the carrier vehicle 11 via which a current position of the satellite vehicle 20 on the receiving area 15 and a current position of the product P located on the satellite vehicle 20 can be detected. The first sensor device 16 transmits corresponding first position signals to a control device 18, which is also arranged on the carrier vehicle 11. The initial first position signals are evaluated in the control device 18, and it is determined whether the satellite vehicle 20 and the product P are correctly positioned on the carrier vehicle 11.

A second sensor device 29 designed with a plurality of lateral sensors 29 is on the satellite vehicle 20, via which the current position of the satellite vehicle 20 on the receiving area 15 of the carrier vehicle 11 can be detected. The second sensor device 24 is wirelessly connected to the control device 18 and transmits corresponding second position signals thereto. In the control device 18, the second position signals are evaluated in addition to the first position signals to determine whether the satellite vehicle 20 and the product P are correctly arranged on the carrier vehicle 11.

A third sensor device 26 is provided on the carrier vehicle 11 which detects the temperature in the environment of the carrier vehicle 11 and the satellite vehicle 20, and transmits corresponding temperature signals to the control device 18.

While the satellite vehicle 20 with the product P drives onto the receiving area 15 of the carrier vehicle 11, the current position of the load L is continuously determined via the first sensor device 16 and the current position of the satellite vehicle 20 via the second sensor device 24, and corresponding first and second position signals are transmitted to the control device 18. The control device 18 continuously or at short time intervals checks whether the satellite vehicle 20 and the product P have reached their respective target position within specified limits. Optionally, correction signals are transmitted from the control device 18 to the propulsion device 25 of the satellite vehicle 20 so that the satellite vehicle 20 changes its position on the carrier vehicle 11 via the propulsion device 25 and therefore also the position of the product P so that both the satellite vehicle 20 as well as the product P are arranged in or near the respective target position.

Once the desired positioning of the satellite vehicle 20 and the product P has been achieved, the lifting device 22 and therefore the support surface 21 of the satellite vehicle 20 together with the product P is lowered until the product P rests on support surfaces 30 of the carrier vehicle 11. The support surfaces 30 are provided with a non-slip coating so that the product P is held securely. Subsequently, the carrier vehicle 11 travels with the satellite vehicle 20 and the product P along the shelf aisle R to a desired location and in particular to the end of the shelf aisle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transport device for storing and retrieving products in a shelf warehouse which has at least one shelf aisle and at least one shelf extending substantially perpendicular to the shelf aisle, the transport device comprising:
a satellite vehicle that is adapted to be moved along the shelf via a propulsion device and has a support surface on which a product is adapted to be supported, and which has a lifting device via which the product is adapted to be raised and lowered relative to a chassis of the satellite vehicle via a lifting drive device;
a carrier vehicle that is movable along the shelf aisle via a drive device and which has a receiving area on which the satellite vehicle is adapted to be arranged with or without a product placed thereon, the carrier vehicle having a first sensor device via which a current position of the satellite vehicle on the receiving area and/or a current position of the product located on the satellite vehicle is detected, and that transmits corresponding first position signals to a control device in which a respective current position is comparable to a target position, the control device being designed such that it sends correction signals to the propulsion device of the satellite vehicle if a deviation between the current position and the target position is greater than a predetermined value.

2. The transport device according to claim 1, wherein the first sensor device is an optical sensor device.

3. The transport device according to claim 2, wherein the first sensor device has at least one camera and/or at least one light barrier and/or at least one optical scanner.

4. The transport device according to claim 1, wherein the control device is arranged on the carrier vehicle and is wirelessly connected to the propulsion device of the satellite vehicle.

5. The transport device according to claim 1, wherein the control device is arranged on the carrier vehicle and is wirelessly connected to the first sensor device.

6. The transport device according to claim 1, wherein the satellite vehicle has a second sensor device with which the current position of the satellite vehicle on the receiving area is detected and that transmits corresponding second position signals to the control device in which the current position of the satellite vehicle is comparable with the target position.

7. The transport device according to claim 6, wherein the second sensor device is an optical sensor device.

8. The transport device according to claim 7, wherein the second sensor device has at least one camera and/or at least one light barrier and/or at least one optical scanner.

9. The transport device according to claim 1, wherein a third sensor device is provided that detects a temperature in a vicinity of the carrier vehicle and/or the satellite vehicle, and sends corresponding temperature signals to the control device.

10. A method for storing and retrieving products in a shelf warehouse that has at least one shelf aisle and at least one shelf extending substantially perpendicular to the shelf aisle, the method comprising:
providing the transport device according to claim 1;
arranging the satellite vehicle with the product arranged on the support surface drives onto the receiving area of the carrier vehicle via the drive-propulsion device and stopping the satellite vehicle there;
detecting, at least after the satellite vehicle has stopped, the current position of the satellite vehicle on the receiving area and/or the current position of the product located on the satellite vehicle via the first sensor device;
transmitting, via the first sensor device, corresponding first position signals to the control device;
comparing the respective current position with the target position via the control device;
providing correction signals by the control device to the propulsion device of the satellite vehicle if the deviation between the current position and the target position is greater than a predetermined value; and
changing the position of the satellite vehicle on the receiving area based on the correction signals via the propulsion device.

11. The method according to claim 10, wherein an optical sensor device is used as the first sensor device.

12. The method according to claim 11, wherein at least one camera and/or at least one light barrier and/or at least one optical scanner is used as the first sensor device.

13. The method according to claim 10, wherein the control device is arranged on the carrier vehicle and is wirelessly connected to the propulsion device of the satellite vehicle.

14. The method according to claim 10, wherein the control device is arranged on the carrier vehicle and is wirelessly connected to first sensor device.

15. The method according to claim 10, wherein the satellite vehicle has a second sensor device with which the current position of the satellite vehicle on the receiving area is detected and that transmits corresponding second position signals to the control device in which the current position is compared with the target position.

16. The method according to claim 15, wherein an optical sensor device is the second sensor device.

17. The method according to claim 16, wherein at least one camera and/or at least one light barrier and/or at least one optical scanner is used as the second sensor device.

18. The method according to claim 10, wherein a third sensor device is provided that detects a temperature in the vicinity of the carrier vehicle and/or the satellite vehicle and sends corresponding temperature signals to the control device.
